(19) United States
(12) Patent Application Publication
(10) Pub. No.: US 2010/0217611 A1
(43) Pub. Date: Aug. 26, 2010

(54) METHOD AND APPARATUS FOR ASSOCIATING CARBON EMISSION REDUCTION CREDITS WITH AGRICULTURAL PRODUCTS

(75) Inventors: John Kenneth Saunders, Castle Rock, CO (US); Leann Mayfield Saunders, Castle Rock, CO (US)

Correspondence Address: HOVEY WILLIAMS LLP, 10801 Mastin Blvd., Suite 1000, Overland Park, KS, 66210, US

(73) Assignee: Integrated Management Information, Inc., Castle Rock, CO (US)

(21) Appl. No.: 12/391,368

(22) Filed: Feb. 24, 2009

(51) Int. Cl. G06Q 50/00

(52) U.S. Cl. 705/1.1

(57) ABSTRACT

A computer-implemented method of associating carbon emission reduction credits (CERCs) with agricultural products. The method includes receiving with a computer system data representative of a number of CERCs assigned to an agricultural producer; receiving with the computer system data representative of an approximate amount of agricultural product produced by the agricultural producer; associating in the computer system the agricultural product produced by the agricultural producer with the CERCs assigned to the agricultural producer; and when the agricultural product is sold by the agricultural producer to a buyer, transferring the CERCs associated with the agricultural product to the buyer.

### BACKGROUND

The present invention relates to carbon emission reduction programs and methods. More particularly, the invention relates to a method and apparatus for associating carbon emission reduction credits with agricultural products.

Most scientists and environmentalists believe that global warming is caused at least partially by the buildup of carbon dioxide and other greenhouse gases in the earth's atmosphere. Although there is disagreement about the potential threats of global warming, there is widespread agreement that it is prudent to enact laws and policies to attempt to slow down the rate of warming.

One of the key provisions to limit atmospheric greenhouse gases is the concept of emission caps and trades. Emission cap and trade programs set a target emissions cap for an industry and then allow members in the industry to trade for the right to exceed a particular emissions rate. An industry member which achieves measured emissions below the target rates may trade the difference on the open market to another which exceeds, or forecasts that it will exceed, its own emission targets. The objective is to reduce the overall emissions of greenhouse gases, even if the emissions of one particular source are not decreased, or indeed are increased.

The generally accepted unit of measure of tradable carbon emissions is the Carbon Emission Reduction Credit, or CERC, which is equivalent to one metric ton of carbon dioxide gas (or other greenhouse gas equivalent). A CERC can be generated for human activities that occurred since 1990 that have resulted in a reduction of emissions of greenhouse gases. For example, CERCs can be generated through energy efficiency gains, use of renewable energy (e.g. solar, wind, methane), substitution of biofuels for fossil fuels, removal of greenhouse gases from industrial gas streams, sequestration of atmospheric carbon dioxide into land or water, (e.g. by reforesting or replanting land), and/or through implementation of agricultural practices that increase the storage of organic matter in the soil.

Markets for trading CERCs exist, but they are costly and inefficient because they rely on CERC consolidators and traders. Thus, the entities which create the CERCs through efficiency gains, sequestration, or other means typically only receive a fraction of the price paid for the CERCs by purchasers. This discourages companies from investing in carbon emission reduction efforts and therefore slows the pace of our country's emission reductions.

Accordingly, there is a need for an improved and more efficient method and system for transferring CERCs from sellers to buyers.

### SUMMARY

The present invention solves at least some of the above-described problems and provides a distinct advance in the art of CERC programs.

The present invention recognizes that the agricultural industry is important to removing carbon emissions from the atmosphere because it is the largest plant factory in the world. Most land west of the Mississippi River is prime land for growing grass and therefore raising cattle, which eat the grass and convert it into protein for human consumption and propagate additional carbon being sequestered in the soil.

The agricultural industry can be broadly divided into two types of entities: agricultural producers or growers such as farms and ranches which generate CERCs through sequestration and other means, and agricultural processors such as cattle slaughterhouses and meat packers which typically need CERCs to offset their emissions. Agricultural producers or growers of course raise livestock or plant crops and therefore control large amounts of land that can be used for carbon sequestration. There are only about 1 million agricultural producers in the United States today, but they own about 80% of the land in the United States. Agricultural processors or packers buy grain, cattle, and other agricultural products from the producers and turn them into food products and other products for consumers. A relatively small number of agricultural processors exist today because of consolidation of smaller processors. Although agricultural processors have made vast improvements in sustainable environmental business practices recently, they are still by far the largest carbon emitters in the agricultural industry and are responsible for a large percentage of the overall carbon emissions in the United States.

The present invention recognizes that agricultural producers and processors have complementary CERC needs and allows them to transfer CERCs directly without using costly and inefficient CERC consolidators and traders. The invention achieves this with a method and system that associates CERCs assigned to an agricultural producer with agricultural products produced by the producer so that the CERCs may be transferred to a buyer such as an agricultural processor along with the agricultural products. The buyer may then use the CERCs to offset its carbon emissions resulting from the processing of the agricultural products.

One embodiment of the invention is a computer-implemented method of associating carbon emission reduction credits (CERCs) with agricultural products comprising: receiving with a computer system data representative of a number of CERCs assigned to an agricultural producer; receiving with the computer system data representative of an approximate amount of agricultural product produced by the agricultural producer; associating in the computer system the agricultural product produced by the agricultural producer with the CERCs assigned to the agricultural producer; and when the agricultural product is sold by the agricultural producer to a buyer, transferring the CERCs associated with the agricultural product to the buyer.

This summary is provided to introduce a selection of concepts in a simplified form that are further described below in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic diagram of exemplary computer equipment that may be used to implement certain aspects of the present invention.

FIG. 2 is a flow chart depicting selected steps in an exemplary method of the present invention.

FIG. 3 is a table or database that may be created by or accessed by the computer equipment of FIG. 1.

FIG. 4 is another table or database that may be created by or accessed by the computer equipment of FIG. 1.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawing figures that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the present invention is defined only by the appended claims, along with the full scope of equivalents to which such claims are entitled.

The present invention associates carbon emission reduction credits (CERCs) assigned to an agricultural producer such as a farm or ranch to agricultural products produced by the producer so that the CERCs may be transferred to a buyer such as an agricultural processor along with the agricultural products. The buyer may then use the CERCs to offset its carbon emissions resulting from the processing of the agricultural products.

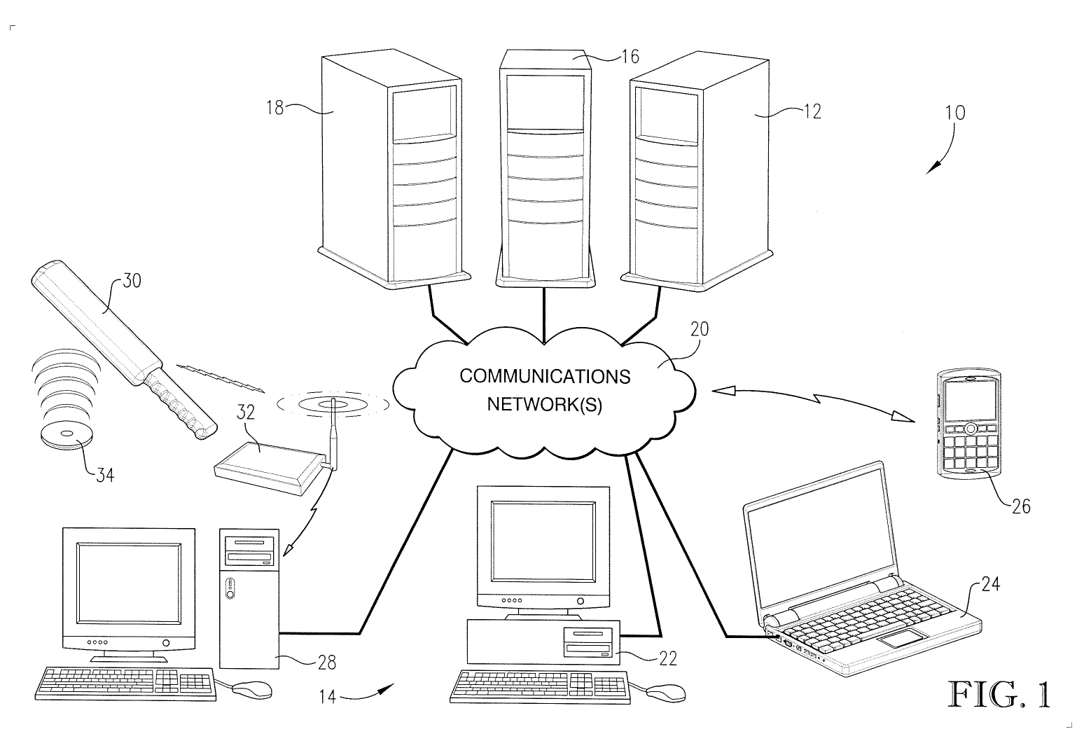

The invention can be implemented in hardware, software, firmware, or a combination thereof. In an exemplary embodiment, the invention is implemented with one or more computer programs that operate computer equipment broadly referred to by the numeral 10 in FIG. 1. The computer equipment 10 may include a host computer 12 operated by a facilitator of a CERC transfer program, a plurality of computing devices generally referred to by the numeral 14 that may be operated by an agricultural producer, a computer or computers 16 that may be operated by an agricultural processor or other buyer, and a computer or computers 18 that may be operated by a CERC regulatory agency or trading company. The various components of the computer equipment 10 may communicate via a communications network 20 such as the Internet, a local area network, a wide area network, a wireless network, or an intranet. The computer programs and equipment 10 illustrated and described herein are merely examples of programs and equipment that may be used to implement the present invention and may be replaced with other programs and computer equipment without departing from the scope of the present invention.

The host computer 12 may be operated by a facilitator or organizer of the CERC transfer program and may serve as a repository for data and programs used to implement certain aspects of the present invention as described in more detail below. The host computer 12 may be any computing device such as a network computer running Windows, Novel, Unix, or any other network operating system. The host computer may include a firewall to prevent tampering with information stored on or accessible by the host computer and may include or be coupled with other computers operated by administrators or others associated with the host computer. The host computer may include conventional web hosting operating software, an Internet connection such as a modem, DSL converter or ISDN converter, and may be assigned a URL and corresponding domain name such as “verifiedgreen.com” so that a website hosted thereon can be accessed via the Internet in a conventional manner.

The computing devices 14 may be operated by owners or employees of a farm, ranch, or other agricultural producer wishing to participate in the CERC transfer program of the present invention. The computing devices 14 may be any types of devices that permit access to the host computer 12 via the communications network 20. For example, the computing devices 14 may include one or more desktop computers 22, one or more laptop computers 24, a handheld personal assistant 26 such as those manufactured and sold by Palm or Blackberry, and a computer 28 in wireless communication with an RFID tag reader 30 and base station 32 configured for reading information from RFID tags 34 worn or attached to cattle or other agricultural products. Each computing device preferably includes or can access a conventional Internet connection such as a modem, DSL converter, or ISDN converter and a web browser that permits it to access the host computer via the communications network 20.

The computer 16 may be operated by a buyer of agricultural products such as a cattle or grain processor, and the computer 18 may be operated by a regulator or facilitator of CERCs such as the Chicago Climate Exchange, American Carbon Registry, C-Lock, or even a governmental agency or bureau. The computers 16 and 18 may be any conventional server or personal-type computers and may be coupled with or include various computer systems.

The computer program or programs of the present invention are stored in or on computer-readable medium residing on or accessible by the host computer 12 or other components of the computer equipment 10 for instructing the computer equipment 10 to perform aspects of the present invention as described herein. Each computer program preferably comprises an ordered listing of executable instructions for implementing logical functions in the host computer 12 or other component of the computer equipment. Each computer program can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electromagnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

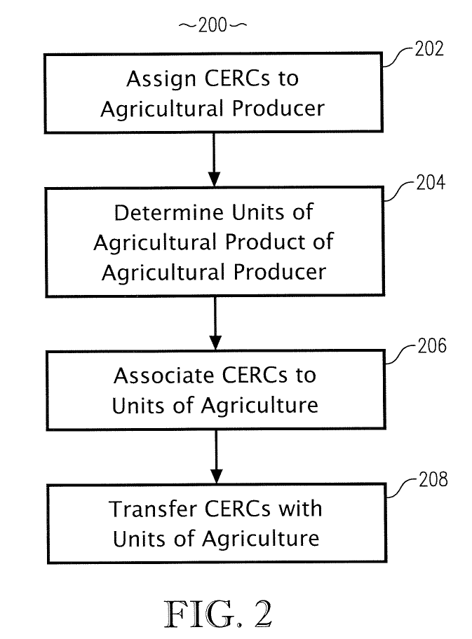

The flow chart of FIG. 2 shows the functionality and operation of an exemplary implementation of the present invention in more detail. In this regard, some of the blocks of the flow chart may represent a module segment or portion of code of the computer programs of the present invention which comprises one or more executable instructions for implementing the specified logical function or functions. In some alternative implementations, the functions noted in the various blocks may occur out of the order depicted in FIG. 2. For example, two blocks shown in succession in FIG. 2 may in fact be executed substantially concurrently, or the blocks may sometimes be executed in the reverse order depending upon the functionality involved.

In step 202, a number of CERCs are assigned to an agricultural producer by a carbon emission regulatory agency or organization such as the Chicago Climate Exchange, the American Carbon Registry, C-Lock, and/or a governmental agency or bureau. The CERCs may be assigned in a conventional manner and may be based on the producer's carbon sequestration, energy efficiency improvements, use of alternative fuels, or any other emission reduction efforts. Methods and programs for generating and assigning CERCs that may be used with the present invention are described in U.S. Pat. Nos. 7,426,489 and 7,457,758, both of which are incorporated into the present application in their entirety by reference. In a preferred embodiment, the CERCs are assigned to the agricultural producer in connection with the producer's sequestration of carbon dioxide into ranch or farming land. For example, a producer with 10,000 acres of land that has been planted with grass or other approved carbon sequestration plants may be awarded 5,000 CERCs per year based on the estimated sequestration of 5,000 tons of carbon dioxide by the land per year.

In step 204, the agricultural products produced by the agricultural producer are identified. The agricultural products may include any livestock, crops, fruits, nuts, milk, eggs, or other products grown on or produced by a farm, ranch, or similar producer. For example, the agricultural producer mentioned in the previous paragraph may raise 200 calves per year on the 10,000 acres of land. Data representative of these calves is gathered and stored in memory accessible by the host computer 12 and associated with the CERCs assigned to the agricultural producer as described in more detail below.

An agricultural provider may provide information about its agricultural products to an administrator of the carbon transfer program in a variety of ways. For example, a producer may submit its contact information to the host computer 12 or an administrator through hard copy, fax, or electronic means, and the host computer 12 may maintain a database of all approved producers. At a producer's request, an administrator of the carbon transfer program may also place an order for electronic RFID tags, visual tags, DNA tags, bar-code tags, or other types of identification for a specific number of animals owned by the producer or other types of agricultural product produced by the producer. The identification tags are then shipped to the producer and tag files are submitted to the host computer 12. The producer then applies the identification to the cattle or other agricultural products. When the cattle or other agricultural products are later transported, subsequent locations can scan or read the identification and access the host computer to retrieve agricultural product and producer information. The host computer maintains the database of all subsequent animal locations, including the packer or processor, to create a seamless trail of information on each animal back to each producer. More details of a process verified program (PVP) are described in U.S. Patent Application Publication No. US/2006/0117301, hereby incorporated by reference into the present application in its entirety.

In step 206, the CERCs assigned to the agricultural producer are associated with the products produced by the agricultural producer. The agricultural products may be divided into units so that the CERCs may be divided amongst the units. Using the above example, each calf raised on the 10,000 acres of land may be considered a “unit” and assigned 25 CERCs. In another example, the agricultural producer may harvest 4 million bushels of corn, wheat, or other crop per year and be assigned 10,000 CERCs per year. In this case, each bushel of crop maybe considered a “unit” and assigned 0.0025 CERCs. The producer may also elect to allocate all of the CERCs to some agricultural products and none to others. For example, a ranch with cattle and grape vineyards may elect to allocate all of the CERCs to the cattle.

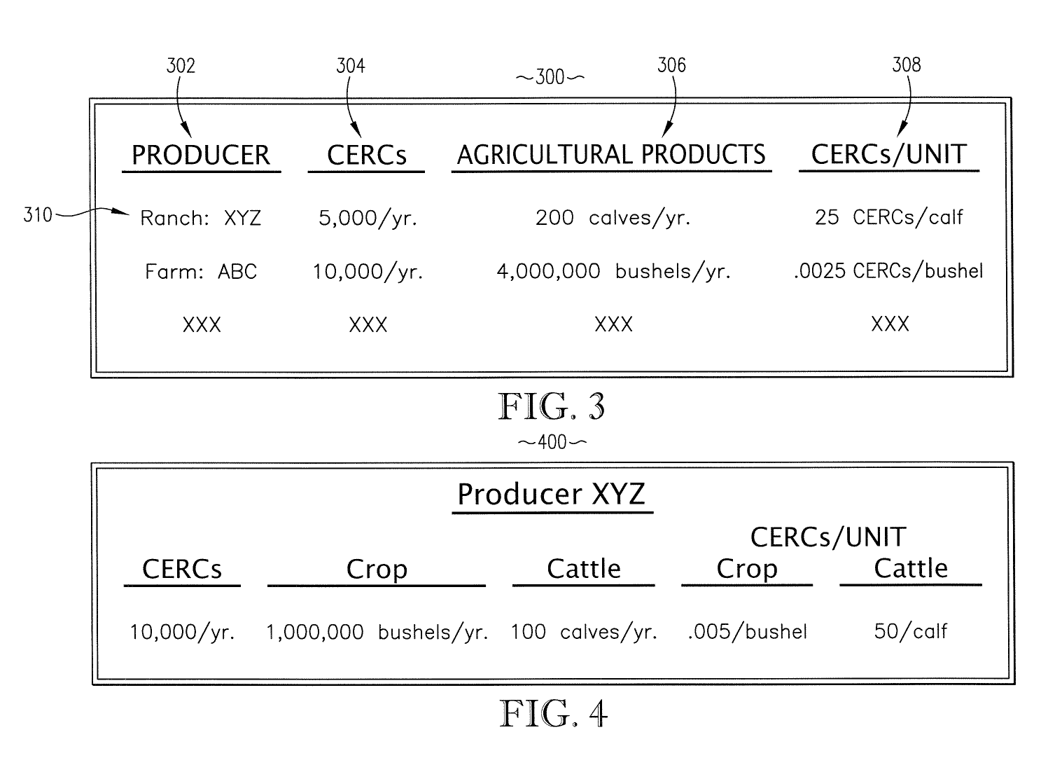

The CERCs may be associated with the agricultural products by storing data representative of the CERCs and the agricultural products in memory accessible by the host computer 12. For example, the host computer may store a database 300 such as the one shown in FIG. 3. The database 300 may include a column 302 that identifies several agricultural producers, a column 304 that lists the number of CERCs assigned to each agricultural producer per year, a column 306 that lists or describes the agricultural products produced by each producer, and a column 308 that lists or describes the number of CERCs assigned to each unit of the agricultural products. For example, line 310 of database 300 shows that Ranch XYZ is assigned 5,000 CERCs per year, raises 200 calves per year, and assigns 25 of the CERCs to each of the calves.

FIG. 4 illustrates another database 400 that may be stored on or accessed by the host computer 12. The database 400 provides more detailed information about a particular agricultural producer. Database 400 shows that Ranch XYZ is assigned 10,000 CERCs per year, grows 1 million bushels of crop per year, raises 100 calves per year, and assigns 0.005 of the CERCs to each bushel of crop and 50 of the CERCs to each calf. The host computer 12 or another component of the computer equipment 10 may maintain a similar database for each and every agricultural producer that participates in the carbon transfer program of the present invention.

Returning to FIG. 2, step 208 transfers the CERCs from the agricultural producer to a buyer along with the associated agricultural products. For example, a meat processor that buys some of the calves raised by Ranch XYZ shown in database 300 of FIG. 3 will be assigned 25 CERCs with each purchased calf. Similarly, a grain processor or other buyer that buys some of the grain produced by Farm ABC shown in database 300 will be assigned 0.0025 CERCs with each purchased bushel of crop.

The computer equipment 10 may facilitate and verify the transfer of CERCs by maintaining a database or other records related to the sale of agricultural products from the agricultural producer to the agricultural processor. For example, the databases of FIGS. 3 and 4 may be linked to related databases with information about the agricultural processors, and the transfer of the CERCs from the producer to the processor may be reflected in the databases for verification purposes. The host computer 12 may also send information reflecting the CERC transfer to the computer 16 operated by the buyer and/or the computer 18 operated by a CERC regulator.

Once the agricultural processor or other buyer obtains the CERCs, it may use them to offset carbon emissions related to the processing of the related agricultural products. The processor may even associate the purchased CERCs with food products that are created with the related agricultural products. For example, if the agricultural processor creates 25 packages of meat from a cow that was purchased along with 25 CERCs, the processor may mark each package of meat with a message that informs final consumers of the carbon emission reductions achieve because of the meat.

From the foregoing description, it can be seen that the present invention provides a unique method of transferring CERCs from an agricultural producer to an agricultural processor that avoids the wastes and inefficiencies of known carbon emission trading programs. The invention further utilizes existing channels of agricultural trade to transfer CERCs. The invention therefore uses a unique and efficient market-driven system to address climate change issues.

Although the invention has been described with reference to the preferred embodiment illustrated in the attached drawing figures, it is noted that equivalents may be employed and substitutions made herein without departing from the scope of the invention as recited in the claims. For example, the particular examples of CERCs assigned to a producer and agricultural products produced by the producer described herein are merely examples and are not meant to limit the claims of the application.

Having thus described the preferred embodiment of the invention, what is claimed as new and desired to be protected by Letters Patent includes the following:

1. A computer-implemented method of associating carbon emission reduction credits (CERCs) with agricultural products, the method comprising:
receiving with a computer system data representative of a number of CERCs assigned to an agricultural producer;
receiving with the computer system data representative of an approximate amount of agricultural product produced by the agricultural producer;
associating in the computer system the agricultural product produced by the agricultural producer with the CERCs assigned to the agricultural producer; and
when the agricultural product is sold by the agricultural producer to a buyer, transferring the CERCs associated with the agricultural product to the buyer.

2. The method as set forth in claim 1, wherein the agricultural product is livestock, crop, fruit, nuts, milk, eggs, lumber, oil, juice, wine, or cheese.

3. The method as set forth in claim 1, further including the steps of receiving with the computer system data representative of an approximate number of units of the agricultural product produced by the agricultural producer and calculating with the computer system an amount of the CERCs to be associated with each of the units of agricultural product.

4. The method as set forth in claim 3, wherein the calculating step permits the agricultural producer to elect the number of CERCs assigned to each unit of the agricultural product.

5. The method as set forth in claim 1, wherein the agricultural producer is a farm or ranch.

6. The method as set forth in claim 1, wherein the buyer is an agricultural processor.

7. The method as set forth in claim 1, further including the step of marking food products produced by the buyer with an indication of the CERCs associated with the agricultural product used to produce the food products.

8. The method as set forth in claim 1, wherein the computer system is a single computer.

9. The method as set forth in claim 1, wherein the computer system includes multiple computers linked by a communications network.

10. A computer-implemented method of associating carbon emission reduction credits (CERCs) with agricultural products, the method comprising:
receiving with a computer system data representative of a number of CERCs assigned to an agricultural producer;
receiving with the computer system data representative of an approximate number of units of agricultural product produced by the agricultural producer;
calculating with the computer system an amount of the CERCs to be associated with each of the units of agricultural product produced by the agricultural producer; and
when at least one of the units of agricultural product are sold by the agricultural producer to a buyer, transferring the CERCs associated with the sold unit of agricultural product to the buyer.

11. The method as set forth in claim 10, wherein the agricultural product is livestock, crop, fruit, nuts, milk, eggs, lumber, oil, juice, wine, or cheese.

12. The method as set forth in claim 10, wherein the calculating step permits the agricultural producer to elect the number of CERCs assigned to each unit of the agricultural product.

13. The method as set forth in claim 10, further including the step of marking food products produced by the buyer with an indication of the CERCs associated with the sold unit of agricultural product used to produce the food products.

14. The method as set forth in claim 10, further including the step of notifying with the computer system a regulator that the CERCs have been transferred to the buyer.

15. A computer readable medium having a computer program stored thereon for directing computer equipment to associate carbon emission reduction credits (CERCs) with agricultural products, the computer program comprising:
a code segment for receiving with a computer system data representative of a number of CERCs assigned to an agricultural producer;
a code segment for receiving with the computer system data representative of an approximate amount of agricultural product produced by the agricultural producer;
a code segment for associating in the computer system the agricultural product produced by the agricultural producer with the CERCs assigned to the agricultural producer; and
a code segment for transferring the CERCs associated with the agricultural product to the buyer when the agricultural product is sold by the agricultural producer to a buyer.

16. The computer readable medium as set forth in claim 15, wherein the agricultural product is livestock, crop, fruit, nuts, milk, eggs, lumber, oil, juice, wine, or cheese.

17. The computer readable medium as set forth in claim 15, further including code segments for receiving with the computer system data representative of an approximate number of units of the agricultural product produced by the agricultural producer and calculating with the computer system an amount of the CERCs to be associated with each of the units of agricultural product.

18. The computer readable medium as set forth in claim 17, wherein the calculating step permits the agricultural producer to elect the number of CERCs assigned to each unit of the agricultural product.

19. The computer readable medium as set forth in claim 15, wherein the agricultural producer is a farm or ranch.

20. The computer readable medium as set forth in claim 15, wherein the buyer is an agricultural processor.

21. The computer readable medium as set forth in claim 15, wherein the computer system is a single computer.

22. The computer readable medium as set forth in claim 15, wherein the computer system includes multiple computers linked by a communications network.
